(19) United States
(12) Patent Application Publication
(10) Pub. No.: US 2011/0173689 A1
(43) Pub. Date: Jul. 14, 2011

(54) NETWORK ID BASED FEDERATION AND SINGLE SIGN ON AUTHENTICATION METHOD

(75) Inventors: Kwihoon Kim, Daejeon-city (KR); Hyun-Woo Lee, Daejeon-city (KR); Won Ryu, Daejeon-city (KR); Bong Tae Kim, Daejeon-city (KR)

(73) Assignee: Electronics and Telecommunications Research Institute, Daejeon-city (KR)

(21) Appl. No.: 13/120,226

(22) PCT Filed: Jul. 22, 2009
(86) PCT No.: PCT/KR2009/004057

§ 371 Date: Mar. 22, 2011

(30) Foreign Application Priority Data
Sep. 23, 2008 (KR) 10-2008-0093387

(51) Int. Cl. H04L 9/32; G06F 21/00

(52) U.S. Cl. 726/8

(57) ABSTRACT

Provided are methods for network ID based federation and single sign on authentication. A method of federating a service providing site in a service network with an access network for web application service authentication in a next generation network (NGN), the method comprising requesting the user equipment for authentication in correspondence with the federation request and inquiring whether to perform the federation, when a federation request is received from user equipment which has been authenticated by the access network; receiving responses to the authentication request and the inquiry from the user equipment; and registering the access network with a user federation list and notifying the federation to the access network, when authentication is determined to be successful from the response.

This application claims the benefit of Korean Patent Application No. 10-2008-0093387, filed on Sep. 23, 2008, in the Korean Intellectual Property Office, the disclosure of which is incorporated herein in its entirety by reference.

### TECHNICAL FIELD

The present invention relates to a method of authentication on a next generation network, and more particularly, to a method of network ID based federation and single sign on (SSO) authentication.

### BACKGROUND ART

Examples of conventional network federated authentication methods include a method of federated single sign on (SSO) authentication between applications recommended by the Liberty Alliance. According to the method, once a subscriber is authenticated for an application service which functions as an identity provider (IdP), the subscriber does not have to be authenticated for other application services. However, since an IdP is an application service, the IdP is vulnerable to hacking. Therefore, it is necessary to improve reliability by employing network devices with high reliability, such as a network attachment control function (NACF) or IP multimedia subsystem (IMS), as IdPs for the SSO authentication.

A web based application authentication method includes one time password (OTP) generation and official certification. Official certification is the most popular method of user authentication in the financial instruments. However, when an individual stores his or her official certificate in a hard disk drive or no security program is installed in his or her computer, there may occur an official certificate usurp or a password leakage. Furthermore, even if a security program is installed, the official certificate may be usurped if the computer is not monitored in real-time. The OTP method is of high security by sharing a password generation key value and then generating a password for one time use every time. However, the OTP has a terminal compatibility problem, and also has vulnerability in a case where the computer itself may be hacked.

In a Next Generation Network (NGN) of the International Telecommunication Union-Telecommunication Standardization Sector (ITU-T) and the Telecoms & Internet Converged Services & Protocols for Advanced Networks (TISPAN), if an NACF L3 level authentication is successful, an IMS L5 level authentication may be omitted according to whether a user has subscribed to bundle authentication. At this time, information whether the user has subscribed to bundle authentication is provided by a service provider's setting. In other words, if the subscriber requests the service provider to set the bundle authentication, the service provider changes the corresponding information on the subscriber. However, if an access network provider has a plurality of service network providers, the user has to decide whether to subscribe to bundle authentication with respect to every service network. If the user has not subscribed to bundle authentication, the user needs to request a federated authentication when the user requests the service network authentication.

### DISCLOSURE OF INVENTION

### Technical Problem

The present invention provides a federation method and federated single sign on (SSO) authentication method when a user subscribes to an access network and to a plurality of application services together in the NGN.

### Technical Solution

According to an aspect of the present invention, there is provided a method of federating a service providing site in a service network with an access network for web application service authentication in a next generation network (NGN), the method comprising requesting the user equipment for authentication in correspondence with the federation request and inquiring whether to perform the federation, when a federation request is received from user equipment which has been authenticated by the access network; receiving responses to the authentication request and the inquiry from the user equipment; and registering the access network with a user federation list and notifying the federation to the access network, when authentication is determined to be successful from the response.

According to another aspect of the present invention, there is provided a method in which a service providing site in a service network performs single sign on (SSO) authentication by federating with an access network in a next generation network (NGN), the method comprising confirming whether to federate with the access network and requesting the user equipment for authentication, if there is an access attempt from user equipment which has been authenticated by the access network; receiving a first authentication context from the user equipment; inquiring for and receiving a second authentication context from the access network; and comparing the first and second authentication contexts and notifying an authentication success to the user equipment if the first and second authentication contexts are identical.

According to still another aspect of the present invention, there is provided a method in which a first node in a service network performs Single Sign On authentication in a next generation network (NGN), the method comprising: receiving a first authentication context for user equipment, which is authenticated in an access network when the first node of the service network is federated with the access network; receiving a second authentication context from a second node of the service network; and transmitting a user service profile to the second node to complete the authentication if the first and second authentication contexts are identical.

According to still another aspect of the present invention, there is provided a method in which a node in an access network performs an authentication by being federated with a service network, the method comprising: when the node receives a request of a user data from the service network, determining whether the node is federated with the service network; and when the node is federated with the service network, adding authentication information to a message including the user data and transmitting the message to the service network.

According to still another aspect of the present invention, there is provided a method in which a first node in a visit access network interact with a second node in a home access network in order to federate with and authenticate the service network when user equipment is roaming in a next generation network, the method comprising: when the first node receives a request of user data from the second node, determining whether the first node is federated with the service network; and when the first node is federated with the service network, adding authentication information to a message including the user data and transmitting the message to the second node.

### DESCRIPTION OF DRAWINGS

The above and other features and advantages of the present invention will become more apparent by describing in detail exemplary embodiments thereof with reference to the attached drawings in which:

FIG. 1 illustrates a conceptual view of a service according to an embodiment of the present invention;

FIG. 2 illustrates a configuration of a communication system for federated authentication with respect to an access network ID based web application service, according to an embodiment of the present invention;

FIG. 3 is a flowchart of a federated authentication method with respect to an access network ID based web application service, according to an embodiment of the present invention;

FIG. 4 is a flowchart of a method of SSO authentication with respect to an access network ID based web application service, according to an embodiment of the present invention;

FIG. 5 illustrates a configuration of a communication system for federated SSO authentication with respect to access network ID based IMS, according to an embodiment of the present invention;

FIG. 6 is a flowchart of a method of federated SSO authentication for an access network ID based IMS, according to an embodiment of the present invention;

FIG. 7 is a flowchart of a method of federated SSO authentication for an access network Id based IMS in a case of roaming, according to an embodiment of the present invention.

### MODE FOR INVENTION

Exemplary embodiments of the present invention will now be described with reference to the attached drawings.

When a user subscribes to an access network and to various application services in NGN, federation type single sign on (SSO) authentication may be provided.

In NGN, an access network provider provides federated authentication regardless of wired access network and wireless access network via a network attachment control function (NACF). NGN user equipment (UE) is connected to NACF via wired/wireless federated access network and is authenticated.

A provider of a service network such as IMS provides IMS authentication method using session initiation protocol (SIP) register with the NGN UE. IMS performs authentication in a MD5-Digest, MD5-AKA method. To simplify the authentication operation, IMS performs authentication using NACF authentication information.

A web application service provider provides ID and password based authentication method to the NGN UE. When the Liberty Alliance standards are applied, a federated ID based SSO authentication method is provided. In other words, when the NGN UE is initially authenticated to an identity provider (IdP), authentications of all federated service relying party (RP) are provided. At this time, if there is a risk that a PC may be hacked due to a web application based IdP, a highly reliable method of network based authentication is necessary.

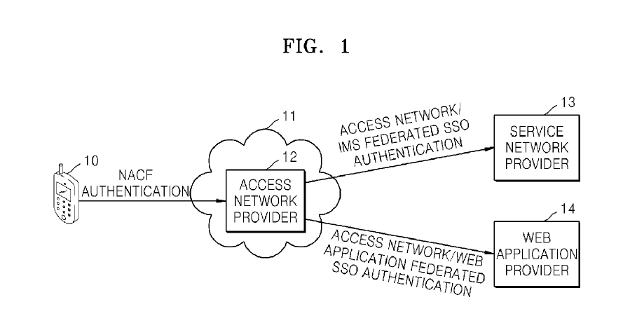

FIG. 1 illustrates a conceptual view of a service according to an embodiment of the present invention. Referring to FIG. 1, when a UE 10 attempts to access a wired/wireless federated access network 11, the UE 10 is authenticated for NACF wired/wireless access federation by an access network provider 12. Once authenticated, the UE 10 is provided federated SSO authentication either between the access network 11 and a service network provider 13 or between the access network 11 and a web application provider 14 is provided.

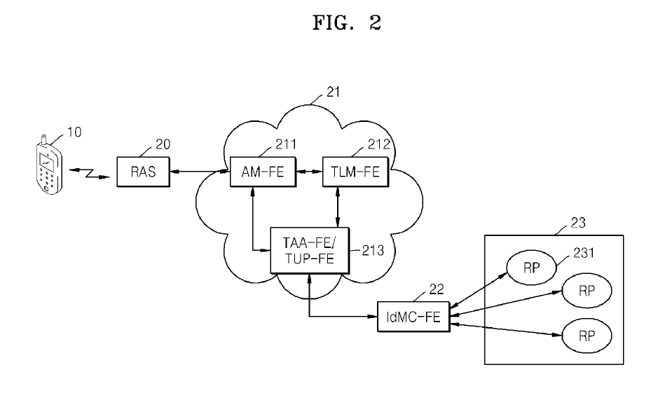

FIG. 2 illustrates a configuration of a communication system for federated authentication with respect to an access network ID based web application service, according to an embodiment of the present invention.

Referring to FIG. 2, a UE 10 accesses a NACF 21, which is an access control network, via a connecting device such as a remote access server (RAS) 20. The NACF 21 performs an IP allocation and access authentication with respect to the UE 10.

The NACF 21 includes an access management functional entity (AM-FE) 211 performing access management, a transport location management functional entity (TLM-FE) 212 managing transport locations, and a transport authentication & authorization functional entity (TAA-FE)/transport user profile functional entity (TUP-FE) 213 performing authentication.

An ID management coordination functional entity (IdMC-FE) 22 manages information regarding IDs of devices forming the NGN.

An application provider 23 includes a plurality of RPs 231, which are web sites accessible by using authenticated IDs.

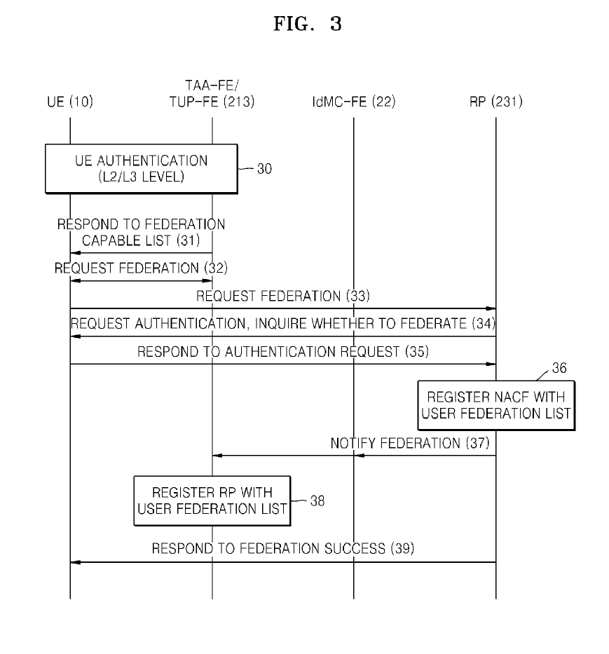

FIG. 3 is a flowchart of a federated authentication method with respect to an access network ID based web application service, according to an embodiment of the present invention.

First, it is assumed that the NACF 21 has completed layer 2(L2)/layer 3(L3) authentications with respect to the UE 10 (operation 30). At this point, if a list of RP 231 providers which have agreed federation with an NACF provider in advance exists, the TLM-FE/TUP-FE 213 includes information of the list of RPs 231 to a response message indicating authentication completion and transfers to the UE 10 (operation 31). A user uses the UE 10 to choose a desired RP 231 provider, search a URL to be federated and then request the TAA-FE/TUP-FE 213 for federation with the corresponding RP 231 (operation 32). If permitted, the user requests the corresponding RP 231 for federation (operation 33). The RP 231 to be federated requests the UE 10 for authentication and inquires whether to perform federation (operation 34). The UE 10 transmits an authentication response message to the RP 231 and informs the RP 231 whether to federate between the RP 231 and TUP-FE 213 (operation 35). Once the authentication is completed, the RP 231 registers the NACF 21 with a federation list of the corresponding user (operation 36). Furthermore, if the RP 231 notifies federation success to the IdMC-FE 23 and the TAA-FE/TUP-FE 213 (operation 37), the TAA-FE/TUP-FE 213 registers the RP 231 with the federation list of the user (operation 38). The IdMC-FE 22 informs the UE 10 of the federation success (operation 39).

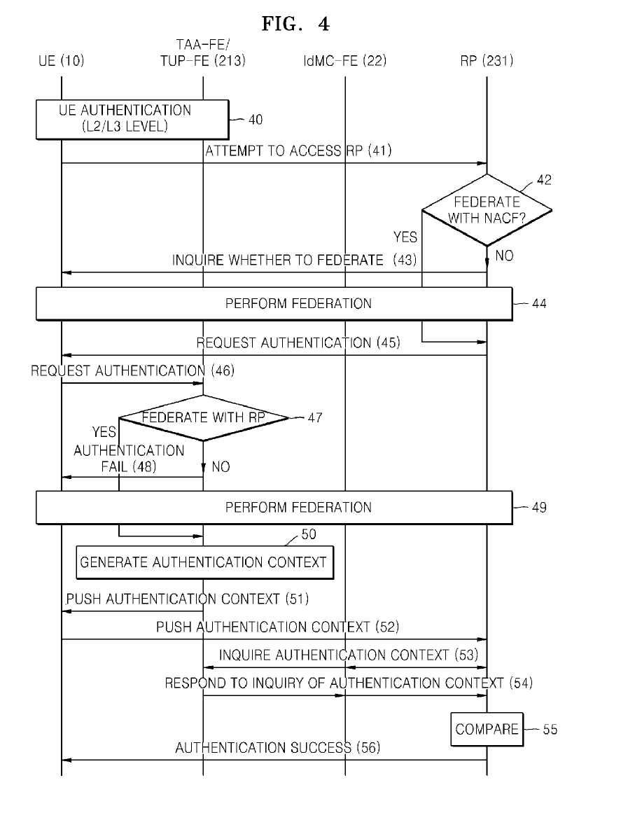

FIG. 4 is a flowchart of a method of SSO authentication with respect to an access network ID based web application service, according to an embodiment of the present invention.

The method shown in FIG. 4 is for a case in which a user has not registered a federation in the method shown in FIG. 3.

First, it is assumed that, after the UE 10 succeeds L3 level authentication via the NACF 21 (operation 40), the UE 10 attempts to access the RP 231, a web site (operation 41).

When attempting to access the RP 231, the RP 231 determines whether the UE 10 is registered with federation with the NACF 21 (operation 42). If the UE 10 is not registered with federation with the NACF 21, the RP 231 inquires the UE 10 to perform federation together with authentication (operation 43), and then performs federation (operation 44). In operation 42, if either the UE 10 is federated with the NACF 21 or the federation of operation 44 is performed, the RP 231 requests the UE 10 for authentication with an address of the TUP-FE 213 included in a request message (operation 45). The UE 10 requests the TUP-FE 213 for authentication by using the received address of the TUP-FE 213 (operation 46). The TUP-FE 213 determines whether the TUP-FE 213 and the RP 231 are registered with federation (operation 47). If the TUP-FE 213 and the RP 231 are not registered with the federation, the TUP-FE 213 informs the UE 10 of authentication failure and requests the UE 10 for the federation (operation 48), and performs the federation (operation 49). In operation 47, if either the TUP-FE 231 and the RP 231 are federated or the federation of operation 49 is performed, the TAA-FE 213 generates an authentication context, which certifies authentication success (operation 50). The TAA-FE 213 pushes the authentication context to the RP 231 via the UE 10 (operation 52). Furthermore, the RP 231 inquires about the authentication context with the TUP-FE 231 via the IdMC-FE 22 (operation 53) and receives a response with respect to the inquiry (operation 54).

The RP 231 compares the authentication context directly received from the UE 10 in operation 52 and the authentication context received from the TUP-FE 231 in operation 54. If the two authentication contexts are identical, the RP 231 determines that authentication is successful (operation 55), and transmits information regarding the authentication success to the UE 10 (operation 56).

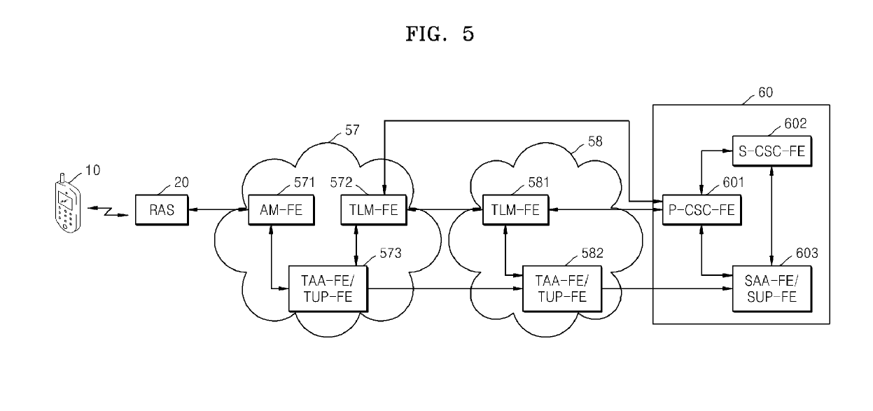

FIG. 5 illustrates a configuration of a communication system for federated SSO authentication with respect to access network ID based IMS, according to an embodiment of the present invention.

Referring to FIG. 5, a UE 10 accesses a visit network 57, which is a wired/wireless communication network, via a connecting device such as a RAS 20. The visit network 57 is connected to a home network 58, which is a wired/wireless communication network. The visit network 57 and the home network 58 are NACFs performing IP allocation and access authentication for the UE 10.

A first NACF 57 includes an AM-FE 571 performing access management, a TLM-FE 572 managing transport locations, and a TAA-FE/ TUP-FE 573 performing authentication.

A second NACF 58 includes a TLM-FE 581 and a TAA-FE/TUP-FE 582, and performs an IdP operation.

An IMS 60 is a service control network performing service routing and service authentication, and includes a proxy call session control functional entity (P-CSC-FE) 601, a serving call session control functional entity (S-CSC-FE) 602, and a service authentication & authorization functional entity (SAA-FE)/service user profile functional entity (SUP-FE) 603.

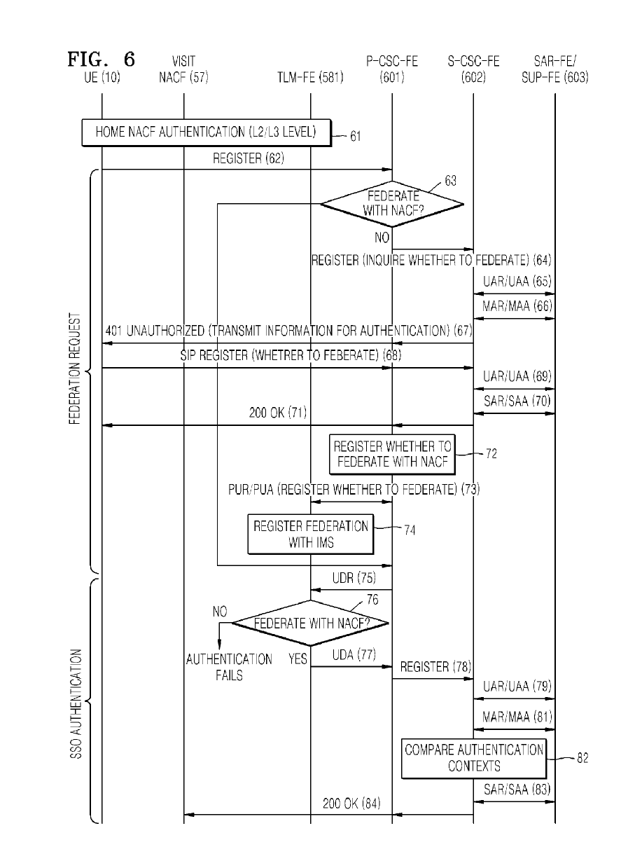

FIG. 6 is a flowchart of a method of federated SSO authentication for an access network ID based IMS, according to an embodiment of the present invention.

First, when the UE 10 is authenticated to the L3 level in the home NACF 58 (operation 61), the UE 10 registers with the IMS 60 by using a REGISTER message (operation 62). The P-CSC-FE 601 of the IMS 60 determines whether the P-CSC-FE 601 is federated with the home NACF 58 (operation 63). If the P-CSC-FE 601 is not federated with the home NACF 58, the P-CSC-FE 601 registers with the S-CSC-FE 602 by using a SIP REGISTER message and requests federation (operation 64). The S-CSC-FE 602 exchanges user authorization request/user authorization answer (UAR/UAA) messages with the SAA-FE/SUP-FE 603 and registers a subscriber with the SAA-FE/SUP-FE 603 (operation 65). Furthermore, the S-CSC-FE 602 exchanges a multimedia authentication request/multimedia authentication answer (MAR/MAA) with the SAA-FE/SUP-FE 603 and obtains authentication information registered with the SAA-FE/SUP-FE 603 (operation 66).

The S-CSC-FE 602 transmits the authentication information obtained in operation 66 to the UE 10 via the P-CSC-FE 601 by using 401 Unauthorized signal (operation 67), and the UE 10 informs S-CSC-FE 602 of whether to federate when the UE 10 is registered with the S-CSC-FE 602 by using a SIP REGISTER message (operation 68). The S-CSC-FE 602 exchanges UAR/UAA messages with the SAA-FE/SUP-FE 603 and registers a subscriber with the SAA-FE/SUP-FE 603 (operation 69), and obtains a user service profile by exchanging server assignment request/server assignment answer (SAR/SAA) messages with the SAA-FE/SUP-FE 603 (operation 70). The S-CSC-FE 602 transmits a 200 ok signal, which is an ACK signal, to the UE 10 (operation 71).

Next, the P-CSC-FE 601 of the IMS 60 registers information regarding whether the P-CSC-FE 601 is federated with the home NACF 58 (operation 72), exchanges profile update request/profile update answer (PUR/PUA) messages with the TLM-FE 581 of the home NACF 58, and informs the TLM-FE 581 of whether federation information is registered (operation 73).

When the TLM-FE 581 registers federation with the IMS 60 (operation 74), the P-CSC-FE 601 transmits a user data request (UDR) message to the TLM-FE 581 and requests a user data (operation 75). The TLM-FE 581 determines whether the TLM-FE 581 is federated with the home NACF 58 (operation 76). If the TLM-FE 581 is federated with the home NACF 58, the TLM-FE 581 pushes an authentication context to the P-CSC-FE 601 by using a user data answer (UDA) message (operation 77). The P-CSC-FE 601 registers the authentication context with the S-CSC-FE 602 by using a REGISTER message (operation 78), and the S-CSC-FE 602 exchanges UAR/UAA messages with the SAA-FE/SUP-FE 603 and registers a subscriber with the SAA-FE/SUP-FE 603 (operation 79). Furthermore, the S-CSC-FE 602 exchanges MAR/MAA messages with the SAA-FE/SUP-FE 603 and receives an authentication context registered with the SAA-FE/SUP-FE 603 (operation 81). Then, the S-CSC-FE 602 compares the received authentication context to the authentication context registered in operation 78 (operation 82). If the two authentication contexts are identical, the S-CSC-FE 602 exchanges SAR/SAA messages with the SAA-FE/SUP-FE 603 and obtains a user service profile (operation 83). The S-CSC-FE 602 transmits a 200 ok signal to the UE 10 (operation 84).

Overall, operations from operation 62 to operation 74 form the federation request operation, and operations from operation 75 to operations 84 form the SSO authentication operation.

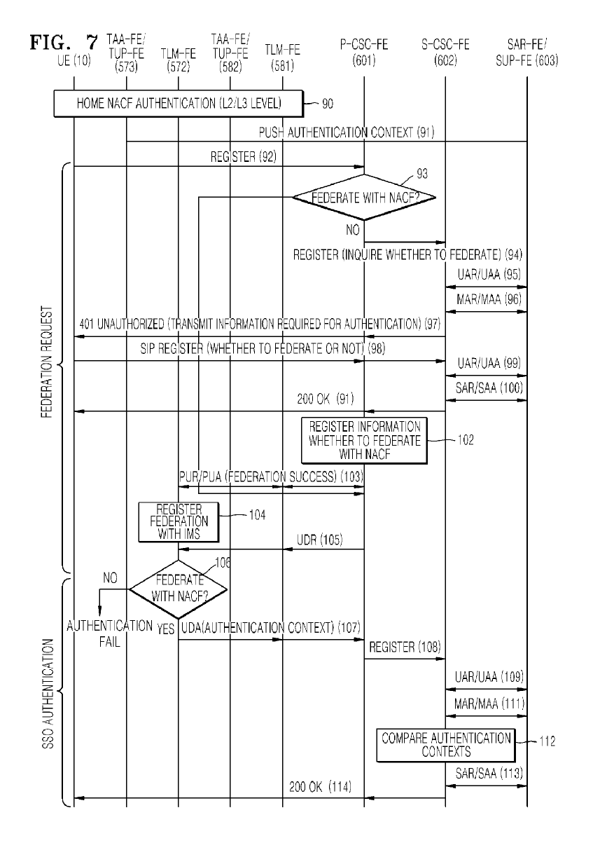

FIG. 7 is a flowchart of a method of federated SSO authentication for an access network Id based IMS in a case of roaming, according to an embodiment of the present invention.

After the UE 10 is authenticated to L3 level in the visit NACF 57 (operation 90), the TAA-FE/TUP-FE 573 of the visit NACF 57 pushes an authentication context to the SAA-FE/SUP-FE 603 of the IMS 60 via the TAA-FE/TUP-FE 582 of the home NACF 58 (operation 91). The UE 10 is registered with the IMS 60 by using a REGISTER message (operation 92). The P-CSC-FE 601 of the IMS 60 determines whether the P-CSC-FE 601 is federated with the visit NACF 57 (operation 93). If the P-CSC-FE 601 is not federated with the visit NACF 57, the P-CSC-FE 601 requests the S-CSC-FE 602 for information of whether to federate when the P-CSC-FE 601 is registered with the S-CSC-FE 602 by using a SIP REGISTER message (operation 94). The S-CSC-FE 602 exchanges UAR/UAA messages with the SAA-FE/SUP-FE 603 and registers a subscriber with the SAA-FE/SUP-FE 603 (operation 95). Furthermore, the S-CSC-FE 602 exchanges MAR/MAA messages with the SAA-FE/SUP-FE 603 and obtains authentication information registered with the SAA-FE/SUP-FE 603 (operation 96).

The S-CSC-FE 602 transmits the authentication information obtained in operation 96 to the UE 10 via the P-CSC-FE 601 by using a 401 Unauthorized signal (operation 97). The UE 10 informs the S-CSC-FE 602 of whether to federate when the UE 10 is registered with the S-CSC-FE 602 by using a SIP REGISTER message (operation 98). The S-CSC-FE 602 registers a subscriber with the SAA-FE/SUP-FE 603 (operation 99) by exchanging UAR/UAA messages with the SAA-FE/SUP-FE 603, and obtains a user service profile by exchanging SAR/SAA messages with the SAA-FE/SUP-FE 603 (operation 100). The S-CSC-FE 602 transmits 200 ok signal, an ACK signal to the UE 10 (operation 101).

Next, the P-CSC-FE 601 of the IMS 60 registers information of whether the P-CSC-FE 601 is federated with the visit NACF 58 (operation 102), and informs TLM-FE 581 of the home NACF 58 of whether to register the federation by exchanging PUR/PUA messages with the TLM-FE 572 of the visit NACF 57 (operation 103) via the TLM-FE 581 (operation 103).

When the TLM-FE 572 registers the federation with the IMS 60 (operation 104), the P-CSC-FE 601 transmits a UDR message to the TLM-FE 572 and requests a user data (operation 105).

The TLM-FE 572 determines whether the TLM-FE 572 is federated with the visit NACF 57 (operation 106). If the TLM-FE 572 is federated with the visit NACF 57, the TLM-FE 572 pushes an authentication context to the P-CSC-FE 601 by using a UDA message via TLM-FE 581 (operation 107). The P-CSC-FE 601 registers the authentication context with the S-CSC-FE 602 by using a REGISTER message (operation 108), and the S-CSC-FE 602 exchanges UAR/UAA messages with the SAA-FE/SUP-FE 603 and registers a subscriber with the SAA-FE/SUP-FE 603 (operation 109). Furthermore, the S-CSC-FE 602 exchanges MAR/MAA messages with the SAA-FE/SUP-FE 603 and receives an authentication context registered with the SAA-FE/SUP-FE 603 (operation 111). Then, the S-CSC-FE 602 compares the received authentication context to the authentication context registered in operation 108 (operation 112). If the two authentication contexts are identical, the S-CSC-FE 602 exchanges SAR/SAA messages with the SAA-FE/SUP-FE 603 and obtains a user service profile (operation 113). The S-CSC-FE 602 transmits a 200 ok signal to the UE 10 (operation 114).

Overall, operations from operation 92 to operation 104 form the federation request operation, and operations from operation 105 to operations 114 form the SSO authentication operation.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of federating a service providing site in a service network with an access network for web application service authentication in a next generation network (NGN), the method comprising:
requesting the user equipment for authentication in correspondence with the federation request and inquiring whether to perform the federation, when a federation request is received from user equipment which has been authenticated by the access network;
receiving responses to the authentication request and the inquiry from the user equipment; and
registering the access network with a user federation list and notifying the federation to the access network, when authentication is determined to be successful from the response.

2. A method in which a service providing site in a service network performs single sign on (SSO) authentication by federating with an access network in a next generation network (NGN), the method comprising:
confirming whether to federate with the access network and requesting the user equipment for authentication, if there is an access attempt from user equipment which has been authenticated by the access network;
receiving a first authentication context from the user equipment;
inquiring for and receiving a second authentication context from the access network; and
comparing the first and second authentication contexts and notifying an authentication success to the user equipment if the first and second authentication contexts are identical.

3. The method of claim 2, further comprising:
if it is determined that the user equipment is not federated with the access network,
requesting the authentication and inquiring whether to perform federation to the user equipment;
receiving responses for the authentication request and the inquiry from the user equipment; and
if the authentication is determined to be successful from the response, registering the access network with a user federation list and notifying the federation to the access network.

4. The method of claim 2, wherein the first authentication context is generated in the access network after the authentication request is made from the user equipment and is pushed to the user equipment.

5. A method in which a first node in a service network performs Single Sign On authentication in a next generation network (NGN), the method comprising:
receiving a first authentication context for user equipment, which is authenticated in an access network when the first node of the service network is federated with the access network;
receiving a second authentication context from a second node of the service network; and
transmitting a user service profile to the second node to complete the authentication if the first and second authentication contexts are identical.

6. A method in which a node in an access network performs an authentication by being federated with a service network, the method comprising:
when the node receives a request of a user data from the service network, determining whether the node is federated with the service network; and
when the node is federated with the service network, adding authentication information to a message including the user data and transmitting the message to the service network.

7. The method of claim 6, prior to the determining whether the node is federated, further comprising:
receiving a message indicating federation of the service network with the access network from the service network; and
registering the federation with the access network for the service network.

8. A method in which a first node in a visit access network interact with a second node in a home access network in order to federate with and authenticate the service network when user equipment is roaming in a next generation network, the method comprising:
when the first node receives a request of user data from the second node, determining whether the first node is federated with the service network; and
when the first node is federated with the service network, adding authentication information to a message including the user data and transmitting the message to the second node.

9. The method of claim 8, prior to the determining whether the first node is federated with the service network, further comprising:
receiving a message indicating federation of the service network with the visit access network from the service network; and
registering the federation with the access network for the service network.
